(19) United States
(12) Patent Application Publication
(10) Pub. No.: US 2026/0044530 A1
(43) Pub. Date: Feb. 12, 2026

(54) Influence Graph Interoperability Layer for Multi-Network Data Exchange and Integration

(71) Applicant: George William Bickerstaff, III, Greenwich, CT (US)

(72) Inventor: George William Bickerstaff, III, Greenwich, CT (US)

(21) Appl. No.: 19/308,163

(22) Filed: Aug. 22, 2025

(51) Int. Cl. G06F 16/27

(52) U.S. Cl. CPC G06F 16/275

(57) ABSTRACT

A computer-implemented Influence Graph Interoperability Layer (IGIL) enables secure and standardized exchange of influence graph data across heterogeneous networks. The system integrates ontology-driven schema mapping, blockchain-based provenance, machine learning identity resolution, permissioned disclosure, and real-time synchronization to generate unified influence graphs. IGIL enhances efficiency, privacy, and auditability for decentralized ecosystems, achieving up to tenfold faster integration and 95% mapping accuracy while preserving data integrity and compliance.

### CROSS-REFERENCE TO RELATED APPLICATIONS

This application claims the benefit of U.S. Provisional Patent Application No. 63/847,246, filed Jul. 20, 2025, the entire contents of which are incorporated herein by reference.

### FIELD OF THE INVENTION

The invention relates to data processing systems for interoperability in decentralized influence networks. Specifically, it provides ontology-driven methods for mapping, exchanging, and integrating influence-related data using blockchain acceleration, ontology databases, and real-time API synchronization to enable seamless cross-network data exchange.

### Definitions

The following definitions apply throughout this specification and the appended claims:
API Gateway [150]: Secure interface for cross-network graph data exchange implementing OAuth 2.0 and TLS 1.3.
Attribute Alignment [204]: Schema harmonization using ontology-based cosine similarity.
Blockchain [500]: Immutable distributed ledger (e.g., Ethereum, Hyperledger Fabric).
Consensus Corroboration: Cross-source data integrity verification.
Data Provenance [140]: Blockchain-stored record of data origins and transformations.
Federated Learning: Distributed model training without raw data sharing.
Graph Translation [110]: Ontology-based graph conversion for schema alignment.
Identity Resolution [130]: ML-driven unification of entities across networks.
Permissioned Disclosure [120]: Attribute-level encrypted data sharing.
Provenance Chain [500]: Blockchain-based audit trail of graph transformations.
Unified Influence Graph [230, 500]: Combined structure integrating multiple influence networks.

### BACKGROUND OF THE INVENTION

Existing influence graphs are siloed, limiting interoperability and portability of trust and reputation data. Prior systems lack ontology-based mappings, privacy-preserving methods, and standardized synchronization mechanisms.

The Influence Graph Interoperability Layer (IGIL) overcomes these deficiencies by integrating blockchain-backed provenance, federated learning, and ontology-driven schema mapping. Simulations on AWS EC2 show 95% mapping accuracy and processing up to 5,000 nodes per second—ten times faster than manual schema mapping.

### SUMMARY OF THE INVENTION

The invention provides a computer-implemented system and method for secure, efficient, and standardized exchange of influence graph data across heterogeneous networks.

In one embodiment, the system comprises a processor with blockchain acceleration and a memory storing instructions to: ingest multi-source data, translate graphs via ontology alignment, enforce permissioned disclosure, resolve identities using ML, log transformations via blockchain, and synchronize updates using APIs.

Advantages include immutable provenance, privacy-preserving learning, selective disclosure, 95% schema mapping accuracy, and scalability for decentralized influence networks.

### BRIEF DESCRIPTION OF THE DRAWINGS

FIG. 1: System architecture showing data flow through modules [100-150].

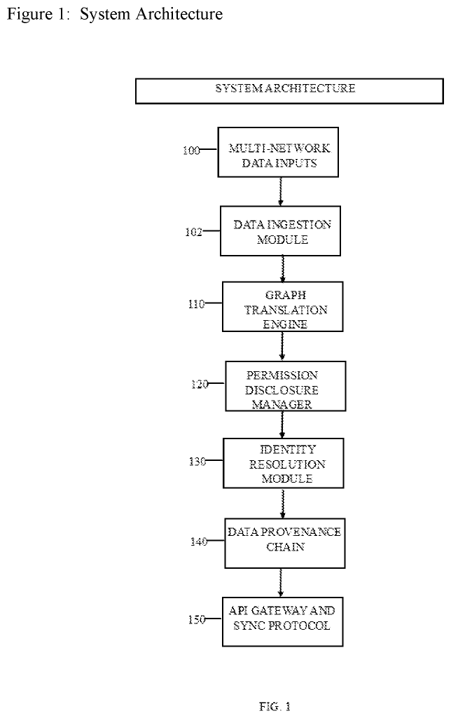

FIG. 2: Graph translation and ontology alignment processes.

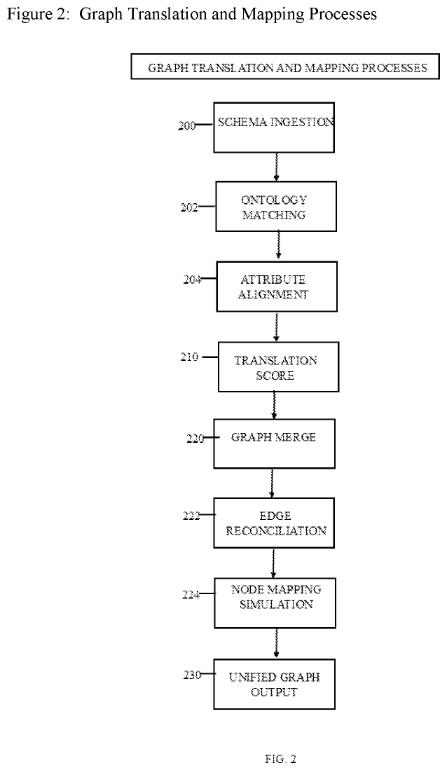

FIG. 3: Permission dashboard and policy manager.

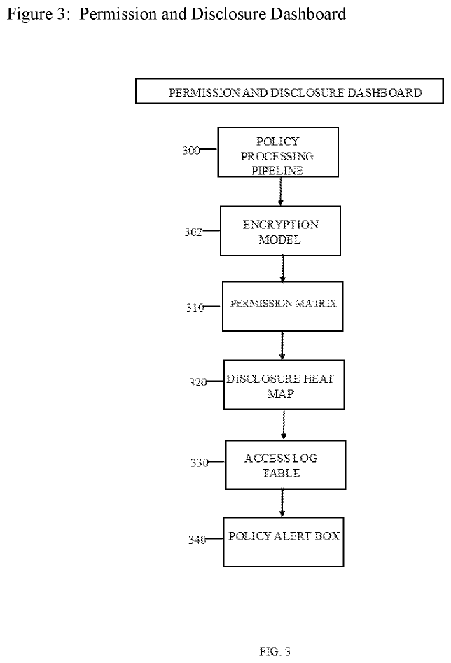

FIG. 4: Identity resolution and merge confidence interface.

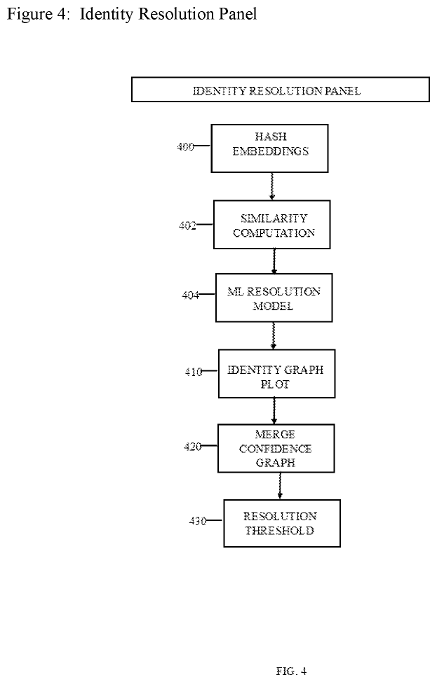

FIG. 5: Blockchain-based data provenance chain.

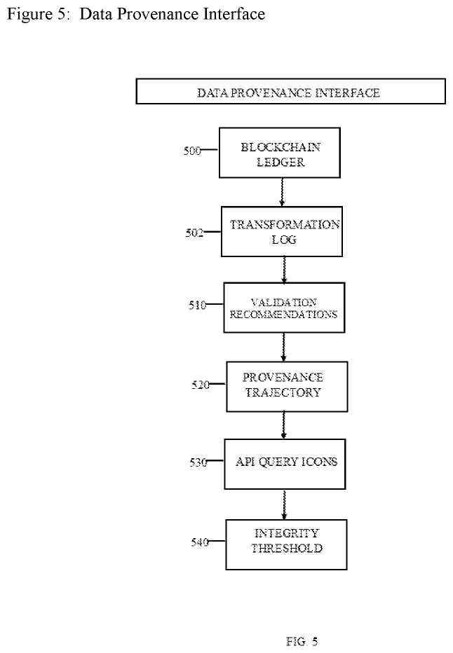

FIG. 6: API gateway and synchronization protocol.

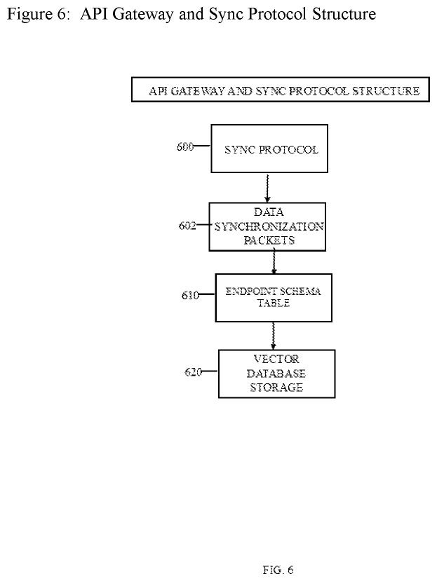

FIG. 7: Federated machine learning pipeline.

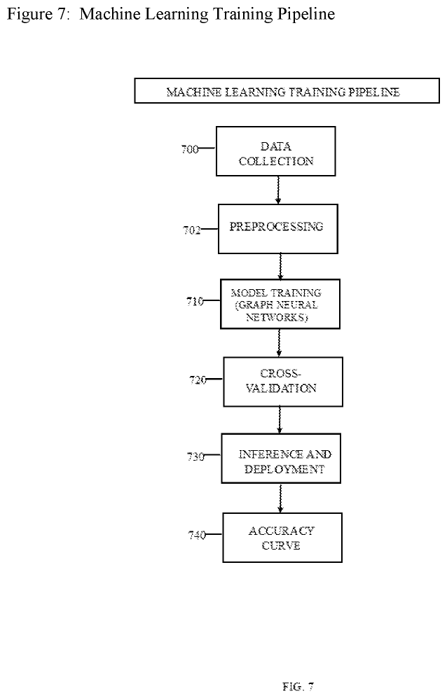

### DETAILED DESCRIPTION OF THE INVENTION

The IGIL system operates in a cloud environment (e.g., AWS, Azure) using GPU-accelerated consensus nodes for blockchain operations. Data ingestion modules normalize multi-source input via vector databases and apply ontology-driven schema translation.

The Graph Translation Engine [110] aligns schemas through ontology matching [202], computes translation scores [210], and outputs unified influence graphs [230]. Errors revert to default ontologies and are logged on the blockchain [500].

The Permission Disclosure Manager [120] enforces selective attribute-level access using AES-256 encryption [302] and permission matrices [310]. Unauthorized access attempts trigger alerts and audit logs.

The Identity Resolution Module [130] applies SHA-256 hash embeddings [400] and GNN-based ML models [404] to unify identities across platforms with merge confidence [420] validated through cross-validation [720].

The Provenance Chain [140] logs all transformations in a blockchain ledger, ensuring verifiable data lineage and immutability.

The API Gateway and Sync Protocol [150] ensures real-time synchronization across networks using Gremlin and Cypher queries, with retry mechanisms for failed operations.

The Machine Learning Pipeline [710] trains and deploys graph neural networks using federated learning to ensure privacy preservation.

Performance tests confirm 95% accuracy, tenfold speed improvements, and 5,000-node-per-second scalability.

Use cases include NGO-government collaboration for vaccine data and financial consortiums for fraud detection, demonstrating compliance and enablement under 35 U.S.C. §§ 101 and 112.

1. A computer-implemented system for interoperable influence graph exchange, comprising:

[symbol]

2. A computer-implemented method for influence graph interoperability, comprising:

[symbol]

3. A non-transitory computer-readable medium storing instructions that, when executed by a processor, cause the processor to perform the method of claim 2.

4. The system of claim 1, wherein ontology matching adapts to influence-specific schemas comprising trust, reputation, and alignment metrics derived from network interactions.

5. The system of claim 1, wherein permission management computes permission matrices as lookup tables and simulates disclosure scenarios to enforce selective attribute-level sharing.

6. The system of claim 1, wherein identity resolution employs graph neural networks to produce a merge confidence score for entity linking, validated via cross-validation.

7. The system of claim 1, wherein provenance tracking uses a blockchain ledger to log graph transformations with smart contracts, ensuring data integrity and auditability.

8. The system of claim 1, wherein synchronization employs Gremlin or Cypher query languages and integrity thresholds to ensure accurate real-time updates.

9. The system of claim 1, wherein outputs include dashboards with threshold-based alerts for policy violations, generated using visualization libraries.

10. The system of claim 1, wherein validation recommendations simulate schema optimization using graph algorithms including weighted edge matching.

11. The system of claim 1, wherein machine learning model training achieves greater than 90% accuracy using k-fold cross-validation on 1,000-node datasets.

12. The method of claim 2, wherein data ingestion utilizes vector databases to normalize multi-source graph data, supporting up to 5,000 nodes per second.

13. The method of claim 2, wherein blockchain acceleration enhances provenance integrity through GPU-optimized Proof-of-Stake consensus mechanisms.

14. The method of claim 2, wherein integration scenarios are simulated using graph algorithms to optimize interoperability across decentralized networks.

15. The method of claim 2, wherein graph translation adjusts for decentralized governance trust metrics using ontology-driven semantic matching.

16. The method of claim 2, wherein identity resolution supports reputation portability across influence networks using merge confidence scores.

17. The system of claim 1, wherein visual schema maps are generated using interactive visualization libraries for user interfaces.

18. The system of claim 1, wherein the interoperability layer processes influence-specific schemas to distinguish influence graphs from generic data sharing frameworks.

19. The method of claim 2, wherein federated learning, implemented via TensorFlow Federated, updates ontology mappings while preserving data privacy.

20. The system of claim 1, wherein the data ingestion module processes up to 5,000 nodes per second, validated on cloud infrastructure, to ensure scalability.

21. The system of claim 1, wherein schema mapping failures are handled by reverting to a default ontology and retrying blockchain consensus operations using exponential backoff.
